(19) United States
(12) Patent Application Publication
(10) Pub. No.: US 2006/0047495 A1
(43) Pub. Date: Mar. 2, 2006

(54) Analyzer for spawning pairs in speculative multithreaded processor

(76) Inventors: Jesus Sanchez, Barcelona (ES); Carlos Garcia, Barcelona (ES); Carlos Madriles, Barcelona (ES); Peter Rundberg, Goteborg (SE); Pedro Marcuello, Barcelona (ES); Antonio Gonzalez, Barcelona (ES)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/933,076

(22) Filed: Sep. 1, 2004

(51) Int. Cl. G06F 9/45

(52) U.S. Cl. 703/22

(57) ABSTRACT

A method for analyzing a set of spawning pairs, where each spawning pair identifies at least one speculative thread. The method, which may be practiced via software in a compiler or standalone modeler, determines execution time for a sequence of program instructions, given the set of spawning pairs, for a target processor having a known number of thread units, where the target processor supports speculative multithreading. Other embodiments are also described and claimed.

### BACKGROUND

1. Technical Field

The present disclosure relates generally to information processing systems and, more specifically, to embodiments of a method and apparatus for analyzing spawning pairs for speculative multithreading.

2. Background Art

In order to increase performance of information processing systems, such as those that include microprocessors, both hardware and software techniques have been employed. One approach that has been employed to improve processor performance is known as “multithreading.” In multithreading, an instruction stream is split into multiple instruction streams that can be executed concurrently. In software-only multithreading approaches, such as time-multiplex multithreading or switch-on-event multithreading, the multiple instruction streams are alternatively executed on the same shared processor.

Increasingly, multithreading is supported in hardware. For instance, in one approach, referred to as simultaneous multithreading (“SMT”), a single physical processor is made to appear as multiple logical processors to operating systems and user programs. Each logical processor maintains a complete set of the architecture state, but nearly all other resources of the physical processor, such as caches, execution units, branch predictors, control logic, and buses are shared. In another approach, processors in a multi-processor system, such as a chip multiprocessor (“CMP”) system, may each act on one of the multiple threads concurrently. In the SMT and CMP multithreading approaches, threads execute concurrently and make better use of shared resources than time-multiplex multithreading or switch-on-event multithreading.

For those systems, such as CMP and SMT multithreading systems, that provide hardware support for multiple threads, several independent threads may be executed concurrently. In addition, however, such systems may also be utilized to increase the throughput for single-threaded applications. That is, one or more thread contexts may be idle during execution of a single-threaded application. Utilizing otherwise idle thread contexts to speculatively parallelize the single-threaded application can increase speed of execution and throughput for the single-threaded application.

### BRIEF DESCRIPTION OF THE DRAWINGS

The present invention may be understood with reference to the following drawings in which like elements are indicated by like numbers. These drawings are not intended to be limiting but are instead provided to illustrate selected embodiments of a method and apparatus for analyzing spawning pairs for a speculative multithreading processor.

FIG. 1 is a block diagram illustrating sample sequential and multithreaded execution times for a sequence of program instructions.

FIG. 2 is a block diagram illustrating at least one embodiment of the stages of a speculative thread, where the speculative thread includes a precomputation slice.

FIG. 3 is a block diagram illustrating at least one embodiment of a processor capable of performing speculative multithreading (SpMT).

FIG. 4 is a flowchart illustrating at least one embodiment of a method for determining the effect of a set of spawning pairs on the modeled execution time for a given sequence of program instructions.

FIG. 5 is a flowchart illustrating at least one embodiment of a method for modeling execution of a sequence of program instructions when the first basic block is encountered.

FIG. 6 is a flowchart illustrating at least one embodiment of a method for modeling execution of a sequence of program instructions when a basic block associated with a spawn point is encountered.

FIG. 7 is a flowchart illustrating at least one embodiment of a method for modeling execution of a sequence of program instructions when a basic block associated with a target point is encountered.

FIG. 8 is a block diagram of at least one embodiment of a SpMT processing system capable of performing a method for evaluating a set of spawning pairs.

FIG. 9 is a block diagram illustrating at least one embodiment of a sample input program trace.

FIG. 10 is a flowchart illustrating at least one embodiment of a method for modeling execution of a sequence of program instructions when a final basic block is encountered.

FIG. 11 is a diagram representing an illustrative main thread program fragment containing three distinct control-flow regions.

### DETAILED DISCUSSION

Described herein are selected embodiments of a method, apparatus and system for analyzing spawning pairs for speculative multithreading. In the following description, numerous specific details such as thread unit architectures (SMT and CMP), number of thread units, variable names, data organization schemes, stages for speculative thread execution, and the like have been set forth to provide a more thorough understanding of the present invention. It will be appreciated, however, by one skilled in the art that the embodiments may be practiced without such specific details. Additionally, some well-known structures, circuits, and the like have not been shown in detail to avoid unnecessarily obscuring the embodiments discussed herein.

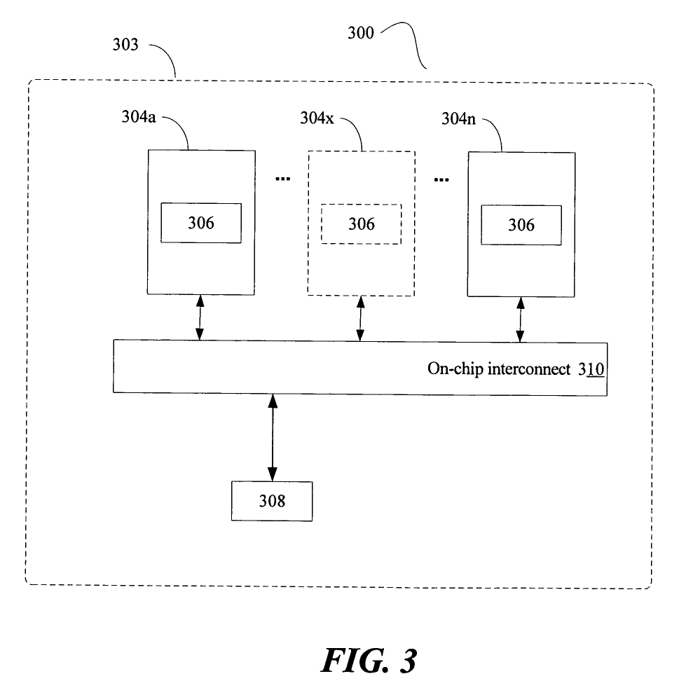

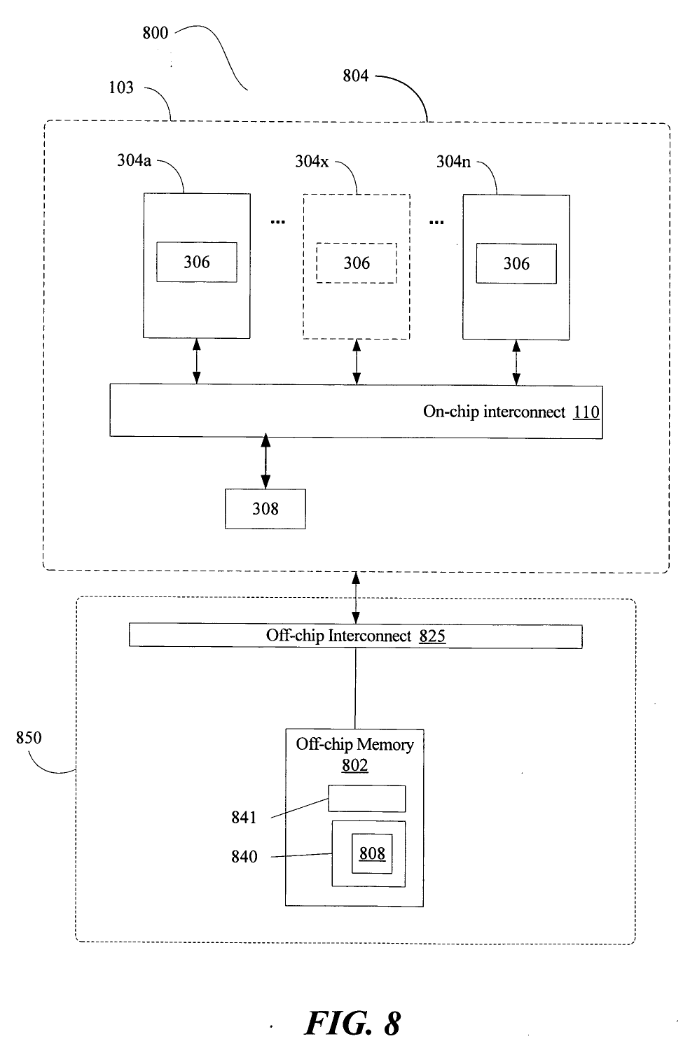

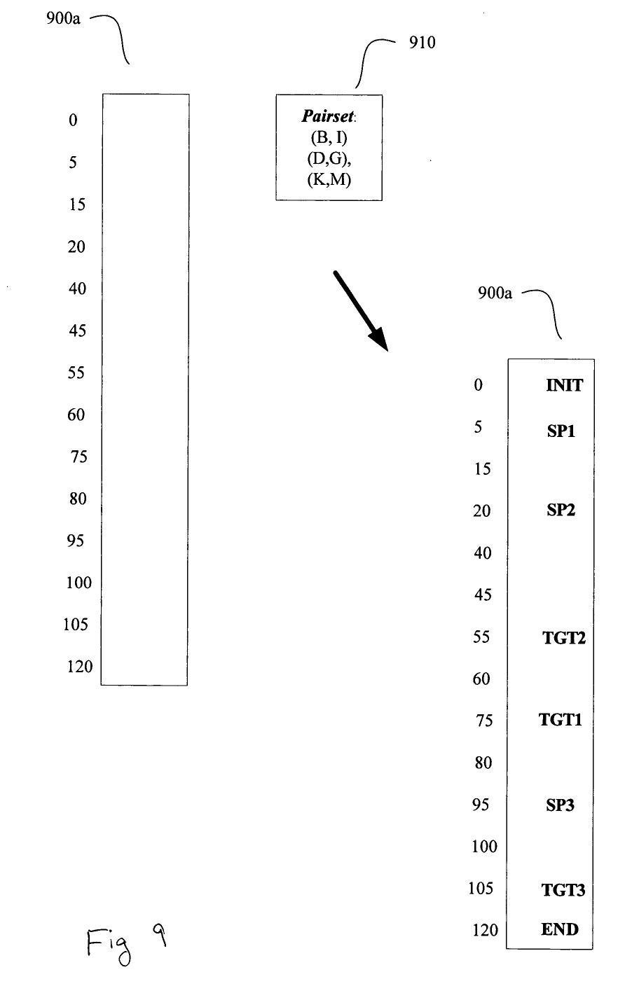

As used herein, the term “thread” is intended to refer to a sequence of one or more instructions. The instructions of a thread are executed in a thread context of a processor, such as processor 300 or processor 800 illustrated in FIGS. 3 and 8, respectively. For purposes of the discussion herein, it is assumed that at least one embodiment of the processors 300 and 800 illustrated in FIGS. 3 and 8, respectively, are equipped with hardware to support the spawning, validating, squashing and committing of speculative threads.

The method embodiments for analyzing spawning pairs, discussed herein, may thus be utilized in a processor that supports speculative multithreading. For at least one speculative multithreading approach, the execution time for a single-threaded application is reduced through the execution of one or more concurrent speculative threads. One approach for speculatively spawning additional threads to improve throughput for single-threaded code is discussed in commonly-assigned U.S. patent application Ser. No. 10/356, 435 “Control-Quasi-Independent-Points Guided Speculative Multithreading”. Under such approach, single-threaded code is partitioned into threads that may be executed concurrently.

For at least one embodiment, a portion of an application's code may be parallelized through the use of the concurrent speculative threads. A speculative thread, referred to as the spawnee thread, is spawned at a spawn point. The spawned thread executes instructions that are ahead, in sequential program order, of the code being executed by the thread that performed the spawn. The thread that performed the spawn is referred to as the spawner thread. For at least one embodiment, a CMP core separate from the core executing the spawner thread executes the spawnee thread. For at least one other embodiment, the spawnee thread is executed in a single-core simultaneous multithreading system that supports speculative multithreading. For such embodiment, the spawnee thread is executed by a second SMT logical processor on the same physical processor as the spawner thread. One skilled in the art will recognize that the method embodiments discussed herein may be utilized in any multithreading approach, including SMT, CMP multithreading or other multiprocessor multithreading, or any other known multithreading approach that may encounter idle thread contexts.

A spawnee thread is thus associated with a spawn point as well as a point at which the spawnee thread should begin execution. The latter is referred to as a target point. These two points together are referred to as a “spawning pair.” A potential speculative thread is thus defined by a spawning pair, which includes a spawn point in the static program where a new thread is to be spawned and a target point further along in the program where the speculative thread will begin execution when it is spawned.

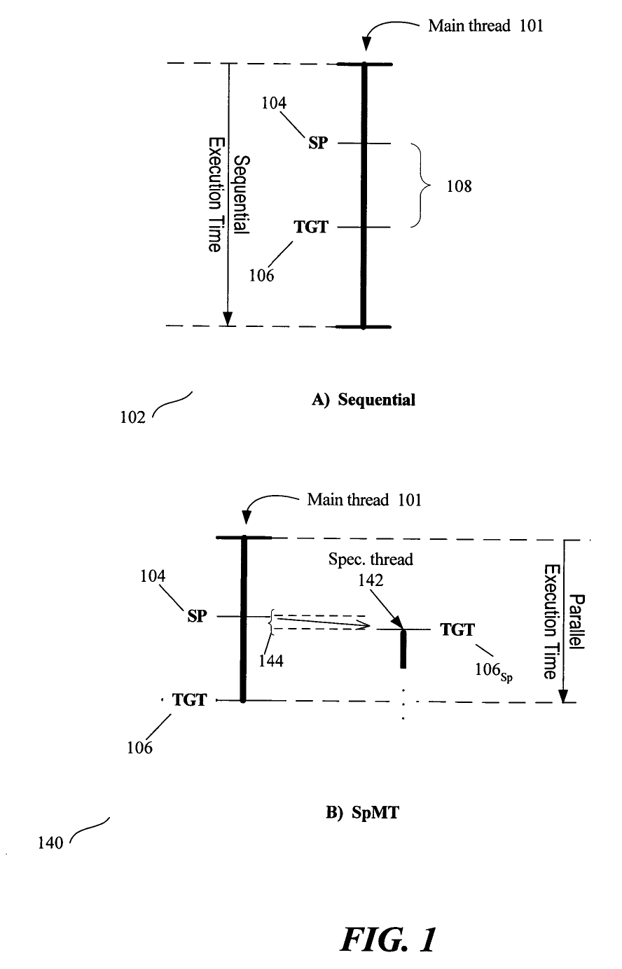

Well-chosen spawning pairs can generate speculative threads that provide significant performance enhancement for otherwise single-threaded code. FIG. 1 graphically illustrates such performance enhancement, in a general sense. FIG. 1 illustrates, at 102, sequential execution time for a single-threaded instruction stream, referred to as main thread 101. For single-threaded sequential execution, it takes a certain amount of execution time, 108, between execution of a spawn point 104 and execution of the instruction at a selected future execution point 106 at which a spawned thread, if spawned at the spawn point 104, would begin execution. As is discussed above, the future execution point 106 may be referred to herein as the “target point.” For at least one embodiment, the target point may be a control-quasi-independent point (“CQIP”). A CQIP is a target point that, given a particular spawn point, has at least a threshold probability that it will be reached during execution.

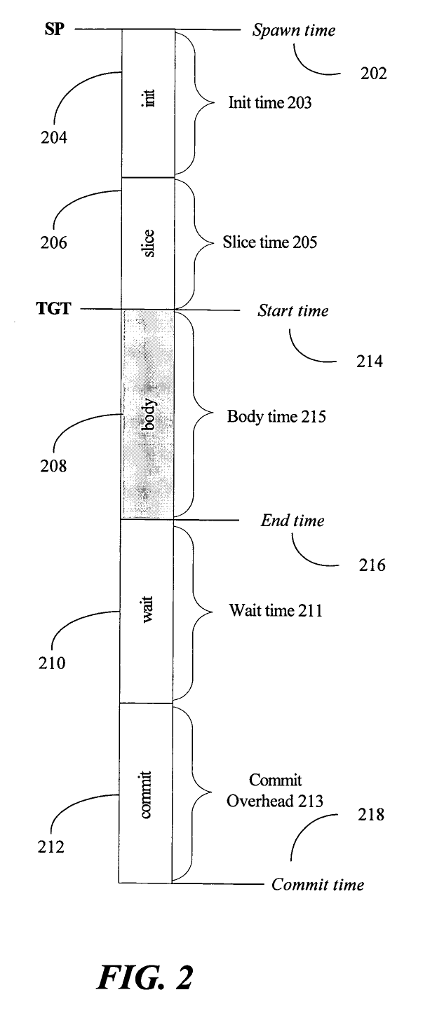

FIG. 1 illustrates, at 140, that a speculative thread 142 may be spawned at the spawn point 104. A spawn instruction at the spawn point 104 may effect a transfer of control. Such instruction may be similar to known spawn and fork instructions, which indicate the address to which control is to be transferred. The target address to which control is transferred in response to a spawn instruction may be the beginning of a sequence of precomputation slice instructions (see, e.g., 206 of FIG. 2). For at least one embodiment, the last instruction in a precomputation slice is an instruction that effects another transfer of control, this time to the target point 106. For purposes of example, the notation 106_{Sp} refers to the target point instruction executed by the speculative thread 142 while the main thread 101 continues execution after the spawn point 104. If such speculative thread 142 begins concurrent execution at the target point 106_{Sp}, while the main thread 101 continues single-threaded execution of the instructions after the spawn point 102 (but before the target point 106), then execution time between the spawn point 104 and the target point may be decreased (see 144).

That is not to say that the spawned speculative thread 142 necessarily begins execution at the target point 106_{Sp} immediately after the speculative thread has been spawned. Indeed, for at least one embodiment, certain initialization and data dependence processing may occur before the spawned speculative thread begins execution at the target point 106. Such processing is represented in FIG. 1 as overhead 144. However, for purposes of simplicity, such overhead 144 associated with the spawning of a speculative thread may be assumed, for at least some embodiments of modeling methods described herein, to be a constant value, such as zero.

FIG. 2 is a block diagram illustrating stages, for at least one embodiment, in the lifetime of a spawned speculative thread (such as, for example, speculative thread 142, FIG. 1). FIG. 2 is discussed herein in connection with FIG. 1.

FIGS. 1 and 2 illustrate that, at a spawn time 202, the speculative thread is spawned in response to a spawn instruction at the spawn point 104 in the main thread 101 instruction stream. Thereafter, initialization processing 204 may occur. Such initialization processing may include, for instance, copying input register values from the main thread context to the registers to be utilized by the speculative thread. Such input values may be utilized, for example, when pre-computing live-in values (see discussion below). The time it takes to execute the initialization processing 204 for a speculative thread is referred to herein as Init time 203. Init time 203 represents the overhead to create a new thread. For at least one embodiment of the methods discussed herein, Init time 203 may be assumed to be a fixed value for all speculative threads.

After such initialization stage 204, a slice stage 206 may occur. During the slice stage 206, live-in input values, upon which the speculative thread is anticipated to depend, may be calculated. For at least one embodiment, such live-in values are computed via execution of a “precomputation slice.” For the embodiments discussed herein, live-in values for a speculative thread are pre-computed using speculative precomputation based on backward dependency analysis. For at least one embodiment, the precomputation slice is executed, in order to pre-compute the live-in values for the speculative thread, before the main body of the speculative thread instructions are executed. The precomputation slice may be a subset of instructions from one or more previous threads. A “previous thread” may include the main non-speculative thread, as well as any other “earlier” (according to sequential program order) speculative thread.

Such live-in calculations may be particularly useful if the target processor for the speculative thread does not support synchronization among threads in order to correctly handle data dependencies. Details for at least one embodiment of a target processor is discussed in further detail below in connection with FIG. 3.

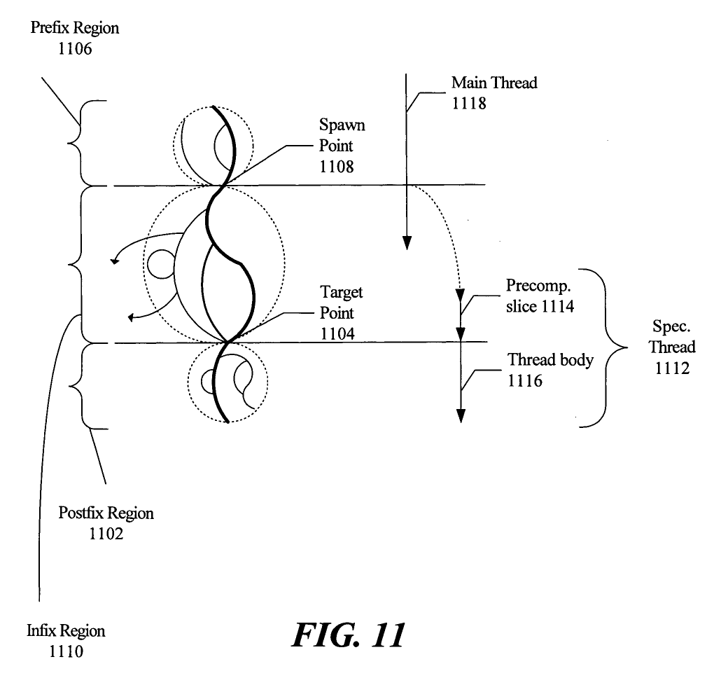

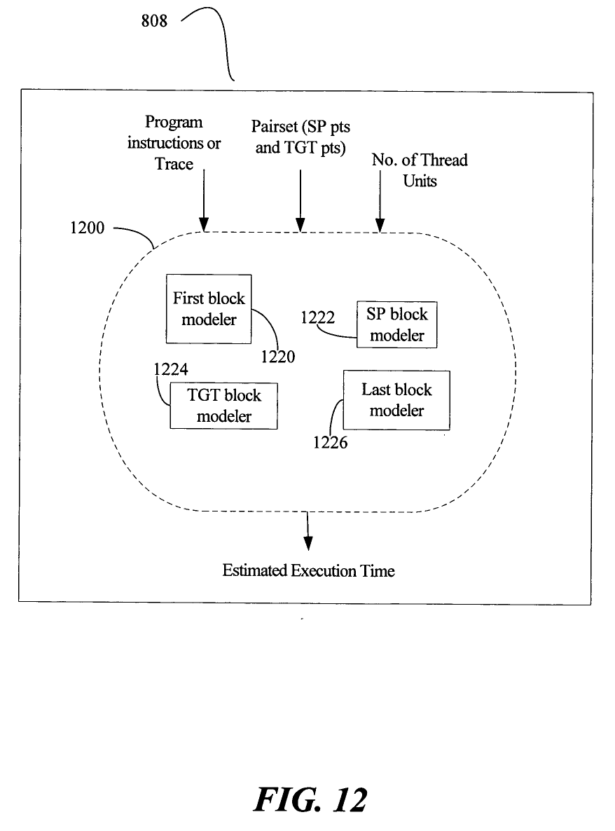

Brief reference is made to FIG. 11 for a further discussion of precomputation slices. FIG. 11 is a diagram representing an illustrative main thread 1118 program fragment containing three distinct control-flow regions. In the illustrated example, a postfix region 1102 following a target point 1104 can be identified as a program segment appropriate for execution by a speculative thread. A spawn point 1108 is the point in the main thread program at which the speculative thread 1112 will be spawned. The target point 1104 is the point at which the spawned speculative thread will begin execution of the main thread instructions. For simplicity of explanation, a region 1106 before a spawn point 1108 is called the prefix region 1106, and a region 1110 between the spawn point 1108 and target point 1104 is called the infix region 1110.

A speculative thread 1112 may include two portions. Specifically, the speculative thread 1112 may include a precomputation slice 1114 and a thread body 1116. During execution of the precomputation slice 1114, the speculative thread 1112 determines one or more live-in values in the infix region 1110 before starting to execute the thread body 1116 in the postfix region 1102. The instructions executed by the speculative thread 1112 during execution of the precomputation slice 1114 correspond to a subset (referred to as a “backward slice”) of instructions from the main thread in the infix region 1110 that fall between the spawn point 1108 and the target point 1104. This subset may include instructions to calculate data values upon which instructions in the postfix region 1102 depend. For at least one embodiment of the methods described herein, the time that it takes to execute a slice is referred to as slice time 205.

During execution of the thread body 1116, the speculative thread 1112 executes code from the postfix region 1102, which may be an intact portion of the main thread's original code.

Returning to FIG. 2, which is further discussed with reference to FIG. 11, one can see that, after the precomputation slice stage 206 has been executed, the speculative thread begins execution of its thread body 1116 during a body stage 208. The beginning of the body stage 208 is referred to herein as the thread start time 214. The start time 214 reflects the time at which the speculative thread reaches the target point and begins execution of the thread body 1116. The start time 214 for a speculative thread may be calculated as the cumulation of the spawn time 202, init time 203, and slice time 205. The time from the beginning of the first basic block of the thread body to the end of the last basic block of the thread body (i.e., to the beginning of the first basic block of the next thread) corresponds to the body time 215.

After the speculative thread has completed execution of its thread body 1116 during the body stage 208, the thread enters a wait stage 210. The time at which the thread has completed execution of the instructions of its thread body 1116 (FIG. 9) may be referred to as the end time 216. For at least one embodiment, end time 216 may be calculated as the cumulation of the start time 214 and the body time 215.

The wait stage 210 represents the time that the speculative thread must wait until it becomes the least speculative thread. The wait stage reflects assumption of an execution model in which speculative threads commit their results according to sequential program order. At this point, a discussion of an example embodiment of a target SpMT processor may be helpful in understanding the processing of the wait stage 210.

Reference is now made to FIG. 3, which is a block diagram illustrating at least one embodiment of a multithreaded processor 300 capable of executing speculative threads to speed the execution of single-threaded code. Such embodiment is referred to herein as a speculative multithreading (“SpMT”) processor. The processor 300 includes two or more thread units 304a-304n. For purposes of discussion, the number of thread units is referred to as “N.” The optional nature of thread units 304 in excess of two such thread units (such as thread unit 304x) is denoted by dotted lines and ellipses in FIG. 3. That is, FIG. 3 illustrates N≧2.

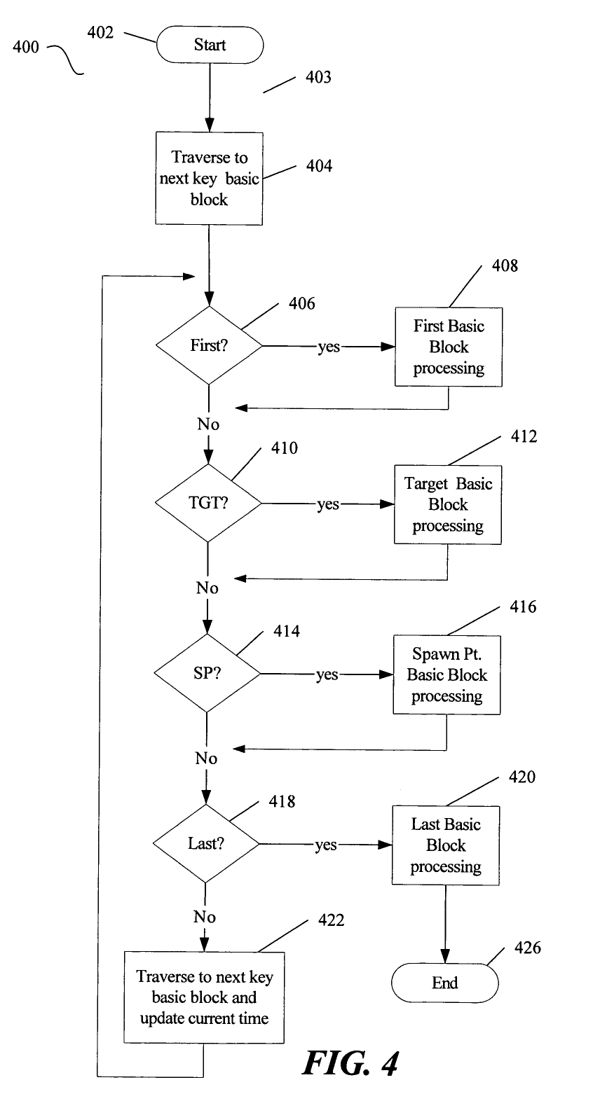

For embodiments of the analysis method discussed herein (such as, for example, method 400 illustrated in FIG. 4), it is assumed that the SpMT processor includes a fixed, known number of thread units 304. As is discussed in further detail below, it is also assumed that, during execution of an otherwise single-threaded program on the SpMT processor 300, there is always one (and only one) non-speculative thread running, and that the non-speculative thread is the only thread that is permitted to commit its results to the architectural state of the processor 300. During execution, all other threads are speculative.

For at least one embodiment, such as that illustrated in FIG. 3, each of the thread units 304 is a processor core, with the multiple cores 304a-304n residing in a single chip package 303. Each core 304 may be either a single-threaded or multi-threaded processor. For at least one alternative embodiment, the processor 300 is a single-core processor that supports concurrent multithreading. For such embodiment, each thread unit 304 is a logical processor having its own instruction sequencer, although the same processor core executes all thread instructions. For such embodiment, the logical processor maintains its own version of the architecture state, although execution resources of the single processor core may be shared among concurrent threads.

While the CMP embodiments of processor 300 discussed herein refer to only a single thread per processor core 304, it should not be assumed that the disclosures herein are limited to single-threaded processors. The techniques discussed herein may be employed in any CMP system, including those that include multiple multi-threaded processor cores in a single chip package 303.

The thread units 304a-304n may communicate with each other via an interconnection network such as on-chip interconnect 310. Such interconnect 310 may allow register communication among the threads. In addition, FIG. 3 illustrates that each thread unit 304 may communicate with other components of the processor 300 via the interconnect 310.

The topology of the interconnect 310 may be a multi-drop bus, a point-to-point network that directly connects each thread unit 304 to each other, or the like. In other words, any interconnection approach may be utilized. For instance, one of skill in the art will recognize that, for at least one alternative embodiment, the interconnect 310 may be based on a ring topology.

According to an execution model that is assumed for at least one embodiment of method 400 (FIG. 4), any speculative thread is permitted to spawn one or more other speculative threads. Because any thread can spawn a new thread, the threads can start in any order. The speculative threads are considered “speculative” at least for the reason that they may be data and/or control dependent on previous (according to sequential program order) threads.

For at least one embodiment of the execution model assumed for an SpMT processor, the requirements to spawn a thread are: 1) there is a free thread-unit 304 available, OR 2) there is at least one running thread that is more speculative than the thread to be spawned. That is, for the second condition, there is an active thread that is further away in sequential time from the “target point” for the speculative thread that is to be spawned. In this second case, the method 400 assumes an execution model in which the most speculative thread is squashed, and its freed thread unit is assigned to the new thread that is to be spawned.

Among the running threads, at least one embodiment of the assumed execution model only allows one thread (referred to as the “main” thread) to be non-speculative. When all previously-spawned threads have either completed execution or been squashed, then the next speculative thread becomes the non-speculative main thread. Accordingly, over time the current non-speculative “main” thread may alternatively execute on different thread units.

Each thread becomes non-speculative and commits in a sequential order. A speculative thread must wait (see wait stage 210, FIG. 2) to become the oldest thread (i.e., the non-speculative thread), to commit its values. Accordingly, there is a sequential order among the running threads. For normal execution, a thread completes execution when it reaches the start of another active thread. However, a speculative thread may be squashed if it violates sequential correctness of the single-threaded program.

As is stated above, speculative threads can speed the execution of otherwise sequential software code. As each thread is executed on a thread unit 304, the thread unit 304 updates and/or reads the values of architectural registers. The thread unit's register values are not committed to the architectural state of the processor 300 until the thread being executed by the thread unit 304 becomes the non-speculative thread. Accordingly, each thread unit 304 may include a local register file 306. In addition, processor 300 may include a global register file 308, which can store the committed architectural value for each of R architectural registers. Additional details regarding at least one embodiment of a processor that provides local register files 306 for each thread unit 304 may be found in co-pending patent application U.S. Pat. Ser. No. 10/896,585, filed Jul. 21, 2004, and entitled “Multi-Version Register File For Multithreading Processors With Live-In Precomputation”.

Returning to FIG. 2, the wait stage 210 reflects the time, after the speculative thread completes execution of its thread body 1116, that the speculative thread waits to become non-speculative. When the wait stage 210 is complete, the speculative thread has become non-speculative. Duration of the wait stage 210 is referred to as wait time 211.

The speculative thread may then enter the commit stage 212 and the local register values for the thread unit 304 (FIG. 3) may be committed to the architectural state of the processor 300 (FIG. 3). The duration of the commit stage 212 reflects the overhead associated with terminating a thread. This overhead is referred to as commit overhead 213. For at least one embodiment, commit overhead 213 may be a fixed value.

The commit time 218 illustrated in FIG. 2 represents time at which the speculative thread has completed the commission of its values. In a sense, the commit time may reflect total execution time for the speculative thread. The commit time for a thread that completes normal execution may be calculated as the cumulation of the end time 216, wait time 211, and commit overhead 213.

The effectiveness of a spawning pair may depend on the control flow between the spawn point and the start of the speculative thread, as well as on the control after the start of the speculative thread, the aggressiveness of the compiler in generating the p-slice that precomputes the speculative thread's input values (discussed in further detail below), and the number of hardware contexts available to execute speculative threads. Additionally, for at least some embodiments, multiple instances of a particular speculative thread can be active at a given point in time. Determination of the true execution speedup due to speculative multithreading must take the interaction between various instances of the thread into account. Thus, the determination of how effective a potential speculative thread will be can be quite complex.

FIG. 4 is a flowchart illustrating a method 400 for analyzing the effects of a set of spawning pairs on the modeled execution time for a given sequence of program instructions. For at least one embodiment, the method 400 may be performed by a compiler (such as, for example, compiler 808 illustrated in FIG. 8). For at least one alternative embodiment, the method 400 may embodied in any other type of software, hardware, or firmware product, including a standalone modeler. The method 400 may be performed in connection with a sequence of program instructions to be run on a processor that supports speculative multithreading (such as, for example, SpMT processors 300, 800 illustrated in FIGS. 3 and 8).

For at least one embodiment, the method 400 may be performed by a compiler to analyze, at compile time, the expected benefits of a set of spawning pairs for a given sequence of program instructions. To perform such analysis, the method 400 models execution of the program instructions as they would be performed on the target SpMT processor, taking into account the behavior induced by the specified set of spawning pairs, and tracks certain information during such modeling.

Thus, during its execution, the method 400 keeps track of certain information as it models expected execution behavior for the sequence of program instructions, given the specified set of spawning pairs. Accordingly, the method 400 may receive as inputs a set of spawning pairs (referred to herein as a pairset) and a representation of a sequence of program instructions.

For at least one embodiment, the pairset includes one or more spawning pairs, with each spawning pair representing at least one potential speculative thread. (Of course, a given spawning pair may represent several speculative threads if, for instance, it is enclosed in a loop). A given spawning pair in the pairset may include the following information: SP (spawn point) and TGT (target point). The SP indicates, for the speculative thread that is indicated by the spawning pair, the static basic block of the main thread program that fires the spawning of a speculative thread when executed. The TGT indicates, for the speculative thread indicated by the spawning pair, the static basic block that represents the starting point, in the main thread's sequential binary code, of the speculative thread associated with the SP.

In addition, each spawning pair in the pairset may also include precomputation slice information for the indicated speculative thread. The precomputation slice information provided for a spawning pair may include the following information. First, an estimated probability that the speculative thread, when executing the precomputation slice, will reach the TGT point (referred to as a start slice condition), and the average length of the p-slice in such cases. Second, an estimated probability that the speculative thread, when executing the p-slice, does not reach the TGT point (referred to as a cancel slice condition), and the average length of the p-slice in such cases.

The sequence of program instructions provided as an input to the method 400 may be a subset of the instructions for a program, such as a section of code (a loop, for example) or a routine. Alternatively, the sequence of instructions may be a full program. For at least one embodiment, rather than receiving the actual sequence of program instructions as an input, the method 400 may receive instead a program trace that corresponds to the sequence of program instructions.

A program trace is a sequence of basic blocks that represents the dynamic execution of the given section of code. For at least one embodiment, the program trace that is provided as an input to the method 400 may be the full execution trace for the selected sequence of program instructions. For other embodiments, the program trace that is provided as an input to the method 100 may be a subset of the full program trace for the target instructions. For example, via sampling techniques a subset of the full program trace may chosen as an input, with the subset being representative of the whole program trace.

In addition to the pairset and the trace (or other representation of program instructions), the method 400 may also receive as an input the number of thread units that are available on the target SpMT processor. As is stated above, at least one embodiment of the method 400 assumes that the number of available thread units is a fixed number. For purposes of simplicity, the examples that are presented below assume only two thread units, TU0 and TU1. However, the embodiments described herein certainly contemplate more than two thread units.

Generally, FIG. 4 illustrates that the method 400 traverses the basic blocks of the input trace. For at least one embodiment, it is assumed that the length (number of instructions) for each basic block in the trace is known, as well as the accumulated length for each basic block represented in the trace. Due to the assumption, discussed above, that each instruction requires the same fixed amount of time for execution, the length and accumulated length values represents the time values. However, for other embodiments, the time needed to execute each basic block, as well as accumulated time, may be determined by other methods, such as profiling, as discussed above.

FIG. 9 illustrates, for purposes of illustration, a sample input trace 900. The trace 900 includes basic blocks A through N. FIG. 9 illustrates the accumulated length value for each of the basic blocks A-N in the trace 900. By simple subtraction, length of each basic block may be determined using the accumulated length values. Note that the accumulated length for the last basic block (such as, for example, N) of a program trace (such as 900) represents the total executed number of sequential instructions of the program.

FIG. 9 also illustrates a sample input pairset 910. The pairset 910 may also include slice information; however, for purposes of simplicity, only the SP and TGT values for each of the spawning pairs is illustrated in FIG. 9. FIG. 9 illustrates that the sample pairset includes the following spawning pairs: (B, I), (D, G), (K, M). In other words, the pairset 910 indicates three speculative threads: one that is spawned at the beginning of basic block B to begin execution at the beginning of basic block I, one that is spawned at the beginning of basic block D to begin execution at the beginning of basic block G, and one that is spawned at the beginning of basic block K to begin execution at basic block M.

From the structure of the trace 900, we can see that the first basic block of the trace is basic block A, beginning at time 0, and the last basic block of the trace 900 is N, which begins (and ends) at time 120. In other words, we may assume that, when the basic blocks were selected for the trace 900, both the first (A) and last (N) basic blocks associated with the full sequence of program instructions were selected to be the first and last, respectively, basic blocks of the trace 900.

In FIG. 9, annotated trace 900b indicates key “events” associated with certain of the basic blocks in the trace 900b, given the contents of the pairset 910 and the structure of the trace 900a. The first basic block, A, is associated with an initialization event for program execution—the earliest non-speculative main thread begins at this basic block. Similarly, the last basic block, N, is associated with a termination event for the program execution. Basic blocks B, D, G, I, K, and M are associated with spawn or trigger points for speculative threads, as specified in the pairset 910.

For each thread, its state is maintained in order to emulate its evolution over its lifetime. The main attribute of this maintained state is the activity currently being performed. The activity may be reflected, for example, by tracking whether the thread is in its slice stage (see 206, FIG. 2), body stage (see 208, FIG. 2), wait stage (see stage 210, FIG. 2), commit stage (212, FIG. 2), etc. Such stages may be assumed to reflect, respectively, execution of an instruction in the precomputation slice, execution of an instruction in the thread body, waiting and validating of some pre-computed values.

Hereinafter, FIG. 4 is discussed with reference to FIG. 9. While traversing the trace, the method 400 keeps track of the threads that are active at any given time. The method 400 may thus analyze the behavior and interactions of the set of spawning pairs as modeled for a given SpMT processor.

As the method 400 traverses the basic blocks in the input trace, two global variables, “current time” and “current thread” (discussed below) are updated. For at least one embodiment, not all basic blocks of the trace are analyzed. Instead, only “key” basic blocks are analyzed. “Key” basic blocks may be defined as the first and last basic blocks of the trace, as well as any basic block that includes the spawn point or target point for any spawning pair in the pairset.

The first global variable, referred to herein as “current time”, reflects the time at which the current basic block instance is being executed. As is stated above, it is assumed that the number of instructions in each basic block is known. For at least one embodiment of the method, the time that it takes a basic block to execute may be computed by multiplying the instructions of a basic block by the execution time needed for each instruction. For the sake of simplicity in discussing selected embodiments of the method 400, it is assumed assume that the execution of any instruction in the trace takes a single unit of time, and that each instruction takes that same amount of time to execute. However, in other embodiments different execution times may be used for each instruction. Such execution times may be determined, for instance, via profiling.

The other global variable that is updated during traversal is “current thread.” The current thread variable indicates the thread that executes the current basic block instance that is under analysis.

The current time and current thread variables may be maintained in a known manner, including variables, records, tables, arrays, objects, etc. For ease of illustration for specific examples, the variable values are illustrated in table format in Tables 2, 3, 5, 7a, 7b, 8, 9, 11a, 11b and 12, below.

As an output, the method 400 may generate an SpMT execution time. The execution time reflects the estimated time required to execute the selected program instructions (as reflected, for instance, in the input program trace), given the speculative threads indicated in the pairset, on a target SpMT machine.

During traversal of the program trace, one or more of the following types of information may be maintained for each thread:
1) Thread Unit: unit on which the thread is being executed
2) Type: May either “normal” or “cancel”. For purposes of determining the current time, it is assumed that a “cancel” thread completes execution at the end of its slice stage (see 206, FIG. 2).
3) Start: Information about the start of the thread. This may include:
   a. Basic block: Identifier of the basic block associated with the target point. May also include a unique identifier of the corresponding dynamic instance of the basic block associated with the target point. For at least one embodiment, the unique identifier may be an accumulated instruction length.
   b. Spawn time: Time when the thread is spawned (see 202, FIG. 2).
   c. Start time: Time when the target point is reached and the body of the thread is started (see 214, FIG. 2). Start time may be calculated as:
      Start time=Spawn time (see 202, FIG. 2)+Init time (see 203, FIG. 2)+Slice time (see 205, FIG. 2). Init time may be a fixed value that represents the overhead needed to create a new thread. The value used for Slice time may be the average length of the slice (either cancel or start slice) for the particular spawning pair.
4) End: Information about the termination of the thread. This may include:
   a. Basic Block: Identifier of the basic block at the end of the thread body. May also include a unique identifier (such as cumulative instruction length) of the corresponding dynamic instance of the basic block. For at least one embodiment, the “end” basic block for a thread is the basic block associated with the target point of the next (in sequential order) speculative thread.
   b. End time: time when the body of the thread completes execution. See 216, FIG. 2. End time may be calculated as:
      End time (see 216, FIG. 2)=Start time (see 214, FIG. 2)+Body time (see 215, FIG. 2). Body time corresponds to the time from the Start basic block to the End basic block. (For at least one embodiment, the End basic block is the first basic block for the beginning of the next speculative thread).
   c. Commit time: time when the thread unit becomes free.
      1. For a thread that completes execution normally, commit time may be calculated as:
         Commit time (see 218, FIG. 2)=End time (see 216, FIG. 2)+Wait time (see 210, FIG. 2)+Commit overhead (see 213, FIG. 2).
         Commit overhead may be, for at least one embodiment, a fixed value that represents the overhead needed to terminate a thread. Wait time may be computed, for at least one embodiment, as the maximum time between the End time of the current thread and the Commit time of the previous thread. In other words, Wait time reflects the overhead due to in-order commitment of thread results
      2. In the case of a thread that is marked as “cancel” (for instance, because its slice does not hit its target point), the commit time may be calculated as:
         Commit time (see 218, FIG. 2)=End time (see 216, FIG. 2)=Start time (see 214, FIG. 2). That is, it is assumed that a cancel thread completes execution at the end of its slice stage (see 206 and 212, FIG. 2).
5) Previous thread: previous thread in sequential order
6) Next thread: next thread in sequential order.

FIG. 4 illustrates that the method 400 begins at block 402 and proceeds to block 404. At block 404, the method 400 traverses the next basic block in the input trace. Processing for the method 400 proceeds to block 406, where it is determined whether the current basic block is the first basic block in the trace. If so, processing proceeds to block 408.

Otherwise, processing proceeds to block 410, where it is determined whether the current basic block is associated with a target point, as defined in the pairset. If so, processing proceeds to block 412. Otherwise, processing proceeds to block 414.

At block 414 it is determined whether the current basic block is associated with a spawn point, as defined in the pairset. If so, then processing proceeds to block 416. Otherwise, processing proceeds to block 418.

At block 418, the method 400 determines whether the current basic block is the last basic block of the trace. If so, processing proceeds to block 420. Otherwise, processing proceeds to block 422. At block 422, the method 400 traverses to the next key basic block in the trace and updates current time. Processing the loops back to block 406, in order to traverse the remaining blocks in the trace.

One of skill in the art will realize that a basic block may be associated with more than one event. For instance, in a trace having a single basic block, the single block will be associated with both an INIT and END event. Similarly, a basic block may be both a spawn point (for one spawning pair) and a target point (for another spawning pair). Also, the first basic block may be associated with a spawn point. Accordingly, FIG. 4 illustrates that, after processing for a particular event has been performed (see blocks 408, 412 and 416), processing proceeds to the next event determination block (see blocks 410, 414, and 418, respectively) instead of ending. In this manner, each basic block is evaluated for each of the INIT, TGT, SP, and END events. One will note that trace traversal processing ends at block 426 after processing 420 for the final basic block of the trace has been completed.

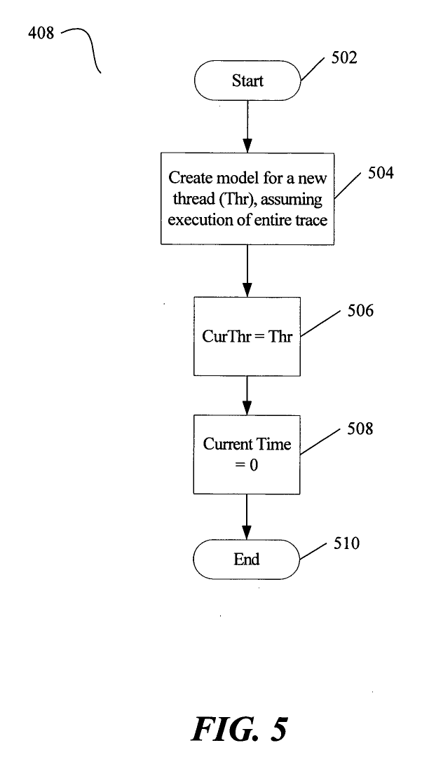

In order to further illustrate operation of the method, FIG. 4 is now discussed in connection with the sample input trace 900b illustrated in FIG. 4. As is stated above, processing begins at block 402 and proceeds to block 404. At block 404, the method 400 traverses the next basic block in the trace. For the example illustrated in FIG. 9, the method 400 traverses to the first basic block, A, at block 404. As is discussed above, and illustrated at 900b, block A is the first basic block of the trace 900b, and is thus associated with an initialization event, INIT. Processing then proceeds to block 408. At block 408, processing is performed for the INIT event. At least one embodiment of such processing is set forth at FIG. 5.

FIG. 5 illustrates at least one embodiment of processing 408 performed for the first block of the input trace 900b. Processing begins at block 502 and proceeds to block 504. Initially, a single, non-speculative thread is assumed. Accordingly, at the first iteration of block 504 for a particular input trace and pairset, the spawning of the single thread, which has no previous thread and no next thread, is modeled. Information to track such modeling is recorded, as illustrated in Table 1, below.

TABLE 1

| | TU | Type | BB_{S} | Time_{SP} | Time_{ST} | BB_{E} | Time_{E} | Time_{C} | Prev | Nxt |
|---|---|---|---|---|---|---|---|---|---|---|
| Thr0 | 0 | Normal | A | null | 0 | N | 120 | 120 | null | null |

Table 1 illustrates the new thread (Thr=Thr0) that is modeled at block 504. Table 1, indicates that the model has spawned a single thread, Thr0, that begins at basic block A and sequentially executes all basic blocks of the trace, through basic block N.

From block 504, processing proceeds to block 506. At block 506, the global current thread value is set to reflect the thread, Thr0, that has been “spawned” at block 504. (One will note, of course, that when the term “spawned” is used in relation to FIG. 4, it is meant that spawning of a thread has been modeled).

From block 506, processing proceeds to block 508. At block 508, the current time is set to time 0, to reflect that execution of the first instruction of the first basic block of the input trace is being modeled. Processing then ends at block 510, and processing proceeds to block 410 of FIG. 4

Table 2 illustrates the global values for current time and current thread, as well as the current basic block and event type, at the end of block 408 processing:

TABLE 2

| Current Time | Current Thread | Current BB | Event |
|---|---|---|---|
| 0 | Thr0 | A | INIT |

Returning to FIG. 4, processing proceeds at block 410. For the sample input trace 900b illustrated in FIG. 9, basic block A is not associated with any other event type besides INIT. Accordingly, the determination at block 410 evaluates to false. Processing proceeds to block 414 and then 418, which both evaluate to false as well. Accordingly, for our example, processing then proceeds to block 422. At block 422, the method 400 traverses to the next key basic block, and updates the current time accordingly. For our example, the next key basic block is basic block B, which is associated with the spawn point of the first spawning pair in the sample pairset illustrated in FIG. 9.

Accordingly, at block 422, the current time is updated to a value of ‘5’ to reflect that basic block A has been traversed. Now, the current basic block being traversed is basic block B. Accordingly, after execution of the first pass of block 422, the value of the global current time and current block values are as set forth in Table 3:

TABLE 3

| Current Time | Current Thread | Current BB | Event |
|---|---|---|---|
| 5 | Thr0 | B | SP |

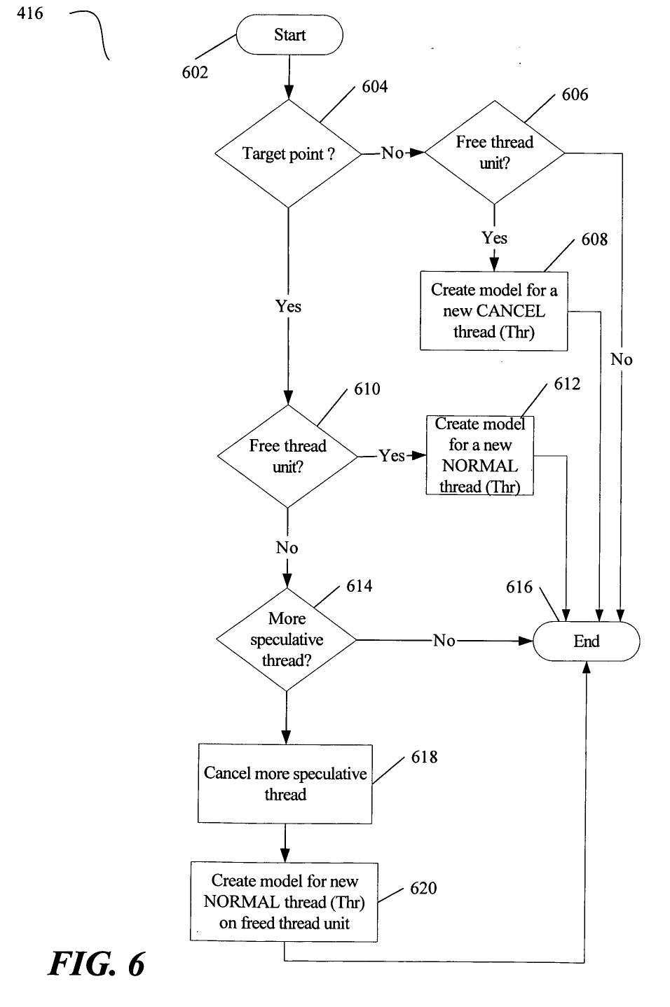

From block 422, processing proceeds to block 406. Because basic block B is associated only with a spawn (SP) event, the determinations at blocks 406 and 410 evaluate to “false”, and processing proceeds to block 414. The determination at block 414 evaluates to “true”, and processing then proceeds to block 416. A more detailed illustration of at least one embodiment of block 416 processing is set forth at FIG. 6.

Turning to FIG. 6, one can see that the processing 416 for a spawn event begins at block 602 and proceeds to block 604. At block 604, the method 400 determines whether a target point associated with current basic block (block B) is present in the annotated trace. For our example, we see in FIG. 9 that basic block I is defined in the pairset as a target point for basic block B, and that basic block I has been included in our trace 900b. Accordingly, the evaluation at block 604 evaluates to true. Processing then proceeds to block 610.

If a target point associated with an SP basic block is not found in the trace, then processing proceeds to block 606. At block 606, it is determined whether a thread unit is available. If not, then processing for block 416 ends at block 616 and processing returns to block 418 of FIG. 4. If so, processing then proceeds to 608. At block 608, a new speculative thread is modeled for the free thread unit, and the type for the new speculative thread identified by the first spawning pair is set to “cancel.” Processing for block 416 then ends at block 616 and processing returns to block 418 of FIG. 4.

If, however, the target point is found, processing proceeds to block 610. In such case, spawning of an additional (speculative) thread should be modeled. At block 610, it is thus determined whether a thread unit is free in order to modeling spawning of the new thread on the free unit. If not, processing proceeds to block 614. At block 614, it is determined whether a currently-allocated thread unit should be freed up for the current speculative thread under consideration. Such processing 614, 618, 620 is discussed in further detail below in connection with sample basic block D.

To determine whether a thread unit is free for the new thread at block 610, the current time is considered. That is, the method 400 searches its modeling information at block 610 to determine whether any thread unit is free at current time 5. For our example, the current modeling information (see Table 1) indicates that a thread unit 0 is busy with Thr0 from time 0 through time 120. Accordingly, it is not free at time 5. However, because we have assumed an SpMT processor that has two thread units, the second thread unit is free. Accordingly, processing proceeds to block 612.

At block 612, an entry for the new speculative thread, Thr1, is modeled. The new thread, Thr1, is spawned at block B, at time 5, and is to begin execution at the beginning of basic block I, and is to execute the remainder of the trace (through basic block N). The trace 900b in FIG. 9 illustrates that basic block N ends at block 120. Accordingly, Table 4, below, indicates that the model reflects, as a result of block 612 processing, that thread Thr1 is modeled to execute on thread unit (“TU”) 1.

TABLE 4

| | TU | Type | BB_{S} | Time_{SP} | Time_{ST} | BB_{E} | Time_{E} | Time_{C} | Prev | Nxt |
|---|---|---|---|---|---|---|---|---|---|---|
| Thr0 | 0 | Normal | A | — | 0 | [symbol] | [symbol] | [symbol] | — | Thr1 |
| | | | | | | I | 75 | 75 | | |
| Thr1 | 1 | Normal | I | 5 | 5 | N | 50 | 75 | Thr0 | — |

Table 4 also reflects that the starting basic block (BBS) for Thr1 is basic block I and that Thr1 is spawned at time 5 (Time_{Sp}). Because execution of Thr1 is modeled as concurrent with execution of Thr0, the cumulative time of 75, as reflected for basic block I in the annotated trace 900b, is not an accurate reflection of the actual time at which Thr1 will begin its modeled execution. Instead, Thr1 will begin execution shortly after it is spawned at time 5. For simplicity, we assume for this example that all init overhead 213 times are zero and that all slice times 205 are zero. With such assumption, start time (Time_{ST}) 214=spawn time (Time_{SP})=5.

The end time (Time_{E}) for Thr1 depends on how long it takes to execute the thread. The cumulative time values illustrated in the annotated trace 900b indicate that the execution of basic block I through basic block 120 takes from sequential cumulative time 75 through time 120. The time to execute Thr1 is therefore 120−75=45. If Thr1 begins its modeled execution at time 5 and takes 45 time units to execute, its end time is thus 45+5=50. Table 4 reflects an end time (Time_{E}) of 50 for Thr1.

One will note that the commit time, Time_{C}, for Thr1 is later than its end time. This is due to the assumed constraint, discussed above, that threads commit their results in sequential program order. Thr1, which begins at time 5, occurs later, in sequential program order, than Thr0, which begins at time 0. Accordingly, the later thread, Thr1, may not commit its results until its previous thread, Thr0, has committed its results. Table 4 indicates a commit time of 75 for Thr1's previous thread, Thr0. Accordingly, Table 4 also reflects a commit time of 75 for Thr1 as well.

Table 4 also reflects changes in the modeling information for Thr0. The new thread, Thr1, will begin execution at basic block I. The first thread, Thr0, need no longer execute the entire trace, but may complete its execution when it reaches basic block I. Accordingly, the model may be updated to reflect that Thr0 is now modeled to be busy only through time 75. At time 75, Thr0 may commit its results. Table 4 reflects this modification. Processing for block 412 then ends at block 616, and returns to block 418 of FIG. 4.

Returning to FIG. 4, we see that processing at block 418 determines whether the current basic block is the last basic block in the trace. For our example, the current basic block (block B) is not the last block in the trace. Accordingly, processing for our example thus proceeds to block 422.

At this second pass of block 422 for our example, the method 400 traverses to the next key basic block and the current time is updated accordingly. For the sample input trace 900b illustrated in FIG. 9, the next basic block is C. But, block C is not a key basic block. Thus, as the third pass of block 404 for our example, the method 400 traverses to the beginning of basic block D, and updates the current time to 20. Such updates are reflected in Table 5:

TABLE 5

| Current Time | Current Thread | Current BB | Event |
|---|---|---|---|
| 20 | Thr0 | D | SP |

Processing then loops back to block 406, falls through the checks at blocks 406 and 410, and proceeds to block 414. At block 414, it is determined that the current block (basic block D) is associated with a spawn event. Processing thus proceeds to block 416, an embodiment of which is, again, illustrated in further detail in FIG. 6.

Turning to FIG. 6, (which is discussed with reference to FIG. 9), one can see that processing proceeds from block 602 to block 604. At block 604, the method 400 determines whether a target point for the spawn point at basic block D is included in the trace 900b. For our example, the pairset indicates that the target point for the second spawning pair is basic block G, which is included in the sample input trace 900b. Accordingly, the determination at block 604 evaluates to “true,” and processing thus proceeds to block 610.

At block 610, it is determined whether a thread unit is available to begin execution at the current time. The modeling information illustrated in Table 4, above, indicates that both thread unit 0 (TU0) and thread unit 1 (TU1), are busy at time 20. That is, TU0 is busy from time 0 to time 75, and TU1 is busy from time 5 to time 75. Accordingly, the evaluation at block 610 evaluates to “false” and processing thus proceeds to block 614.

At block 614 it is determined whether the most speculative thread that is currently modeled as busy is modeled as executing a thread that is more speculative than the speculative thread under consideration. The most speculative thread may be identified as that thread denoted as “normal” type and having a null value for its “next thread” value.

For our example, Table 4 indicates that most speculative thread is the thread modeled for TU1, because it has a null value in its next thread field. Table 4 indicates that the speculative thread modeled for TU1 has a target point associated with basic block I, which begins at sequential cumulative time 75.

The speculative thread under consideration is the speculative thread indicated by the second spawning pair—the indicated target point is associated with beginning of basic block G, which begins at sequential cumulative time 55.

The thread currently modeled for TU1 is thus more speculative that the thread under consideration, because it is designated to begin execution at a point farther from the beginning of the trace (according to sequential program order). Accordingly, there is a more speculative that can be squashed in order to allow modeled spawning of a speculative thread for the second spawning pair in the pairset 910. The evaluation at block 614 thus evaluates to “true,” and processing proceeds to block 618.

At block 618, the thread currently modeled for the thread unit to be freed is canceled. This is accomplished, in part, by marking the thread as “cancel” type. For a canceled thread, commit time=end time=time that the thread is canceled. Table 5, above, indicates that the current time, at which the thread is being canceled, is time 20. Accordingly, commit time for the canceled thread is time 20. In addition, the previous thread and next thread for a canceled thread are null. Accordingly, Table 6 reflects that the commit time, end time, next thread and previous thread for Thr1 are updated accordingly at block 618. Processing then proceeds to block 620.

At block 620, an entry for the new speculative thread, Thr2, is modeled. Table 6, below, indicates that the model reflects, as a result of block 620 processing, that thread Thr2 is modeled to execute on newly freed thread unit (“TU”) 1. The new thread, Thr2, is spawned at block D, at time 20, and is to begin execution at the beginning of basic block G, and is to execute the remainder of the trace (through basic block N). The trace 900b in FIG. 9 illustrates that basic block N ends at block 120.

TABLE 6

| | TU | Type | BB_{S} | Time_{SP} | Time_{ST} | BB_{E} | Time_{E} | Time_{C} | Prev | Nxt |
|---|---|---|---|---|---|---|---|---|---|---|
| Thr0 | 0 | Normal | A | 0 | 0 | [symbol] | [symbol] | [symbol] | null | [symbol] |
| | | | | | | [symbol] | [symbol] | [symbol] | | Thr2 |
| | | | | | | G | 55 | 55 | | |
| Thr1 | 1 | [symbol] | I | 5 | 5 | N | [symbol] | [symbol] | [symbol] | null |
| | | Cancel | | | | | 20 | 20 | null | |
| Thr2 | 1 | Normal | G | 20 | 20 | N | 85 | 85 | Thr0 | null |

Table 6 also reflects that the starting basic block (BBS) for Thr2 is basic block G and that Thr2 is spawned at time 20 (Time_{SP}). For Thr2, spawn time (Time_{SP}) start time (Time_{ST})=20.

Again, the end time (Time_{E}) for Thr2 depends on how long it takes to execute the thread. The cumulative time values illustrated in the annotated trace 900b indicate that the execution of basic block G through basic block N takes from sequential cumulative time 55 through time 120. The time to execute Thr2 is therefore 120−55=65. If Thr2 begins its modeled execution at time 20 and takes 65 time units to execute, its end time is thus 20+65=85. Table 6 reflects an end time (Time_{E}) of 85 for Thr2.

Because the end time (Time_{E}) for Thr2 occurs after then commit time indicated for Thr0, Thr2 need not wait to commit its results. Accordingly, Time_{E}=85=Time_{C} for Thr2.

Table 6 also reflects changes in the modeling information for Thr0. The new thread, Thr2, will begin execution at basic block G. The first thread, Thr0, need no longer execute the trace up to basic block I, but may complete its execution when it reaches basic block G. Accordingly, the model may be updated to reflect that Thr0 is now modeled to be busy only until time 55. At time 55, Thr0 may commit its results. Table 6 reflects this modification. Processing for block 412 then ends at block 616, and returns to block 418 of FIG. 4.

Returning to FIG. 4, we see that processing at block 418 determines whether the current basic block is the last block of the trace. For our example, the current basic block (block D) is not the last block in the trace. Accordingly, processing for our example thus proceeds to block 422.

At this third pass of block 422 for our example, the method 400 traverses to the next key basic block and the current time is updated accordingly. For the sample input trace 900b illustrated in FIG. 9, the next basic blocks are E and F. But, blocks E and F are not a key basic blocks. Thus, at the third pass of block 422 for our example, the method 400 traverses to the beginning of basic block G. Such state is reflected in Table 7a:

TABLE 7a

| Current Time | Current Thread | Current BB | Event |
|---|---|---|---|
| 55 | Thr0 | G | TGT |

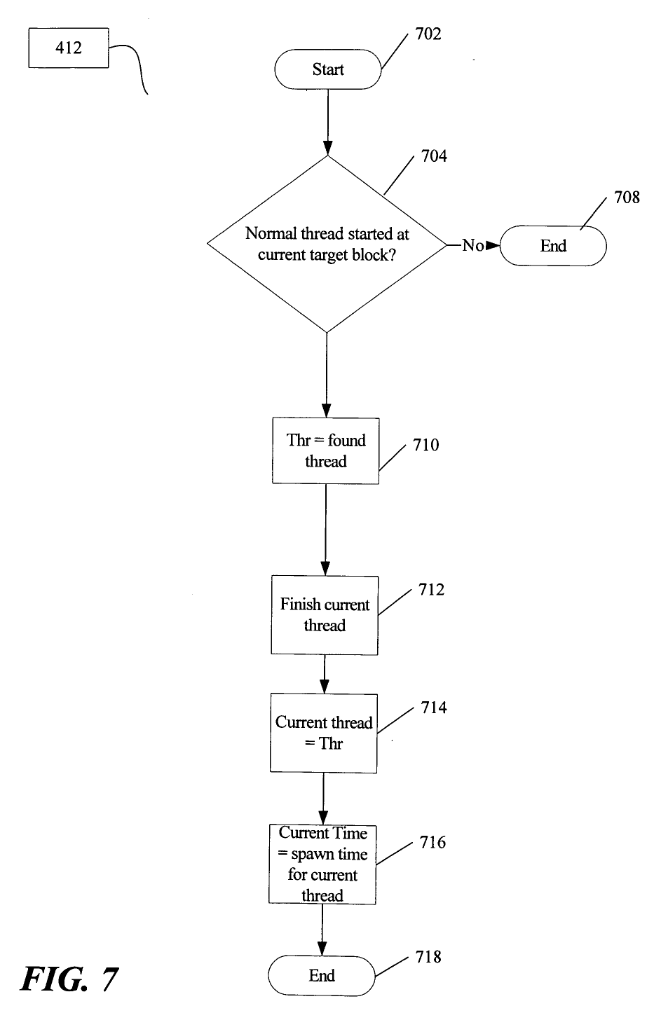

From block 422, processing loops back to block 406, falls through the check at block 406, and proceeds to block 410. At block 410, it is determined that the current block (basic block G) is associated with a target event. Processing thus proceeds to block 412, an embodiment of which is illustrated in further detail in FIG. 7.

Turning to FIG. 7 (which is discussed with reference to FIG. 9), one can see that processing for one embodiment of block 416 begins at block 702 and proceeds to block 704. At block 704, it is determined whether a thread has previously been modeled to begin at the current block. (See blocks 612 and 620 of FIG. 6). If not, then processing ends at block 708.

If, however, the determination at block 704 evaluates to “true,” then a thread, other than the current thread, has been modeled to begin execution at the current basic block. For the example trace 900b illustrated in FIG. 9, Table 6 illustrates that Thr2 has been modeled to start at the current basic block during a prior pass through the method 400. Accordingly, the determination at block 704 evaluates to “true,” and processing proceeds to block 710.

At block 710, an internal variable, Thr, is set to the thread that was identified at block 710. For our example, Thr=Thr2 at block 710. Processing then proceeds to block 712.

At block 712, modeling for completion of the current thread (i.e., Thr0) is completed. One will note that, as is reflected above in Table 6, thread T0 may commit its results at time 55. Accordingly, at block 712 the method 400 models commitment of Thr0 values. Other thread completion tasks may also be modeled at block 712. Processing then proceeds to block 714.

At block 714, the global current thread value is updated. The current thread variable indicates that thread that executes the current basic block instance that is under analysis. As is reflected in Table 6, above, the current basic block instance under analysis is the instance of basic block G that is to begin execution at current time 20. Such instance is performed by Thr2, not Thr0. Because Thr0 has completed execution, the current thread is now updated, for our example, to reflect Thr2. Processing then proceeds to block 716.

At block 716, the global current time value is updated. That is, Table 6 reflects that Thr2 is modeled to begin its execution at time 20. Thus, the current time is 20. The modifications that occur at blocks 714 and 716 are reflected in Table 7b.

TABLE 7b

| Current Time | Current Thread | Current BB | Event |
|---|---|---|---|
| 20 | Thr2 | G | TGT |

From block 716, processing ends at block 718. Processing then proceeds back to block 414 of FIG. 4. Because basic block G is neither associated with a spawn point nor the last block of the trace, processing falls through the evaluations at blocks 414 and 418, and processing proceeds to block 422.

During the fourth iteration of block 422, the method 400 traverses to the next key basic block in the trace, which is block I. The current time is updated accordingly. Because block I is performed by a separate thread (Thr2) that is modeled to execute concurrently with the first thread (Thr0) discussed above, the sequential cumulative time value (75) for 1 that is reflected in the sample trace 900b does not reflect the actual current time at which basic block I is modeled to execute. Table 6 indicates that Thr2 begins execution at basic block G at a current time of 20. The sample trace 990b indicates that G is associated with sequential cumulative time 55 and block I is associated with sequential accumulated time 745. Thus, the time from the beginning of Thr2 execution until execution of basic block I is 75−55=20. Because Thr2 is modeled to begin execution at a current time of 20, current time for execution of basic block I is 20+20=40. Accordingly, the current time is updated at the fourth iteration of block 422 as indicated in Table 8:

TABLE 8

| Current Time | Current Thread | Current BB | Event |
|---|---|---|---|
| 40 | Thr2 | I | TGT |

From block 422, processing loops back to block 406, falls through the check at block 406, and proceeds to block 410. At block 410, it is determined that the current block (basic block I) is associated with a target event. Processing thus proceeds to block 412, an embodiment of which is, again, illustrated in further detail in FIG. 7.

Turning to FIG. 7, (which is discussed with reference to FIG. 9), one can see that processing proceeds from block 702 to block 704. At block 704 it is determined whether a normal thread was previously spawned to begin at current time 40. Consultation with Table 6 indicates that none has been. (Note that Thr1 has been canceled). Processing for block 412 thus ends at block 708 and proceeds back to block 414 of FIG. 4.

Returning to FIG. 4, one can see that processing then falls through the checks at blocks 414 and 418, because basic block I is neither associated with a spawn point nor the last block of the trace 900b. Accordingly, processing proceeds to block 422.

For the fifth iteration of block 422 for our example, the method 400 traverses to the next key basic block in the sample trace 900b. The method 400 thus traverses to basic block K, and the current time is updated accordingly. Regarding current time, one can see that basic block K is associated, in the annotated sample trace 900b, with cumulative sequential time 95. Because Thr2 is modeled to begin execution at time 55, the time it takes to execute to the beginning of basic block K may be modeled as 95−55 =40. Because execution of thread Thr2 is modeled to begin at current time 20, current time for execution of basic block K in Thr2 is 20+40=60. Table 9 reflects these modifications that occur at the fifth iteration of block 422:

TABLE 9

| Current Time | Current Thread | Current BB | Event |
|---|---|---|---|
| 60 | Thr2 | K | SP |

From block 422, processing loops back to block 406, falls through the checks at blocks 406 and 410, and proceeds to block 414. The determination at block 414 evaluates to “true” because, as is illustrated in sample trace 900B, basic block K is associated, for our example, with a spawn event. Processing thus proceeds to block 416. A more detailed illustration of at least one embodiment of block 416 processing is, again, set forth at FIG. 6.

Turning to FIG. 6 (which is discussed with reference to FIG. 9), one can see that the processing 416 for a spawn event begins at block 602 and proceeds to block 604. At block 604, the method 400 determines whether a target point associated with current basic block (block K) is present in the annotated trace. For our example, we see in FIG. 9 that basic block M is defined in the pairset as a target point for basic block K, and that basic block M has been included in our trace 900b. Accordingly, the evaluation at block 604 evaluates to true. In such case, spawning of an additional (speculative) thread should be modeled. Processing then proceeds to block 610.

At block 610, it is determined that thread unit TU0 is free. Table 9 reflects that the current time is 60, and Table 6 reflects that Th0, which was modeled to execute on TU0, will have completed execution by current time 55. Accordingly, the determination at block 610 evaluates to “true,” and processing proceeds to block 612.

At block 612, a new thread is modeled to begin execution on TU0, much in the manner described above in connection with block 612 and Thr1. A new thread (Thr3) is modeled to spawn at basic block I, to begin execution of basic block M at current time 60. Accordingly, Table 10, below, indicates that the model reflects, as a result of current block 612 processing, that thread Thr3 is modeled to execute on thread unit (“TU”) 1.

TABLE 10

| | TU | Type | BB_{S} | Time_{SP} | Time_{ST} | BB_{E} | Time_{E} | Time_{C} | Prev | Nxt |
|---|---|---|---|---|---|---|---|---|---|---|
| Thr0 | 0 | Normal | A | 0 | 0 | [symbol] | [symbol] | [symbol] | null | [symbol] |
| | | | | | | [symbol] | [symbol] | [symbol] | | Thr2 |
| | | | | | | G | 55 | 55 | | |
| Thr1 | 1 | [symbol] | I | 5 | 5 | N | [symbol] | [symbol] | [symbol] | null |
| | | Cancel | | | | | 20 | 20 | null | |
| Thr2 | 1 | Normal | G | 20 | 20 | [symbol] | [symbol] | [symbol] | Thr0 | [symbol] |
| | | | | | | M | 70 | 70 | | Thr3 |
| Thr3 | 0 | Normal | M | 60 | 60 | N | 75 | 75 | Thr2 | null |

Table 10 also reflects that the starting basic block (BBS) for Thr1 is basic block I and that Thr3 is spawned at current time 60 (Time_{SP}), with a start time (Time_{ST}) of 60.

The end time (Time_{E}) for Thr3 is reflected in Table 10 as 75. The cumulative time values illustrated in the annotated trace 900b indicate that the execution of basic block M through basic block N takes from sequential cumulative time 105 through time 120. The time to execute Thr3 is therefore 120−105=15. If Thr3 begins its modeled execution at time 60 and takes 15 time units to execute, its end time is thus 60+15=75. Table 10 thus reflects an end time (Time_{E}) of 75 for Thr3.

Table 10 also reflects changes in the modeling information for Thr2. The new thread, Thr3, will begin execution at basic block M. The previous thread, Thr2, need no longer execute the entire trace, but may complete its execution when it reaches basic block M. Accordingly, the model may be updated to reflect that Thr2 is now modeled to be busy only through time 70. The value of 70 is calculated as follows. Table 10 reflects that Thr2 begins execution at current time 20. Modeled execution time for (basic block G through basic block L)=105−55=50. The duration value of 50, added to the start time value of 20=70.

Accordingly, Thr2 may commit its results at time 70. Thus, at time 75, Thr3 need not wait for its prior thread to commit, and may immediately commit its own results. Table 10 thus reflects that commit time for Thr3 is 75.

From block 612, processing for block 416 then ends at block 616. Processing then returns to block 418 of FIG. 4. Because the current basic block, K, is not, in our example, the last basic block of the sample trace 900b, processing falls through the check at block 418, and processing proceeds to block 422.

At the sixth iteration of block 422, the method 400 traverses to the next key block in the trace, which is block M. Block M is associated, for our example, with a target event. Specifically, block M is designated in the sample pairset 910 as the target point for the spawn point at basic block K. Accordingly, processing for basic block M is performed along the same lines as is discussed above in connection with block 412, basic block G and FIG. 7.

The modifications made as a result of the sixth iteration of block 422 are reflected in Table 11a. The modifications made as a result of blocks 714 and 716 (FIG. 7) are reflected in Table 11b:

TABLE 11a

| Current Time | Current Thread | Current BB | Event |
|---|---|---|---|
| 70 | Thr2 | M | TGT |

TABLE 11b

| Current Time | Current Thread | Current BB | Event |
|---|---|---|---|
| 60 | Thr3 | M | TGT |

Processing for block 416 is performed for basic block M, processing proceeds to block 418, which evaluates to “false,” because block M is not the last block of the trace. Processing then proceeds to block 422.

For the seventh iteration of block 422, for our example, the method 400 traverses to block N, the last block of the sample trace 900b, and the current time is updated accordingly. Table 12 reflects such processing:

TABLE 12

| Current Time | Current Thread | Current BB | Event |
|---|---|---|---|
| 75 | Thr3 | N | TGT |

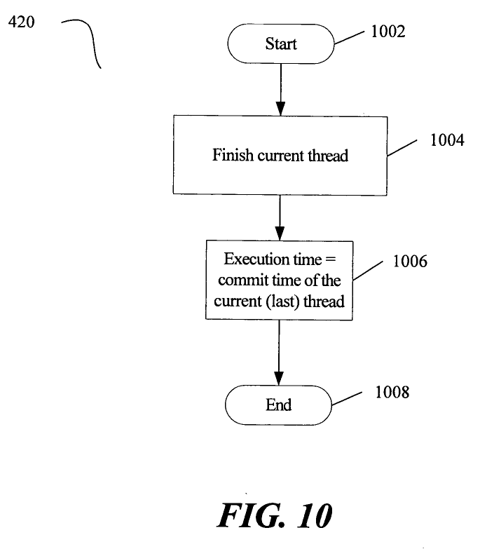

Processing then loops back to block 406, falls through the checks at blocks 406, 410, and 414, and processing proceeds to block 418. Because block N is the last basic block of the sample trace 900b, the determination at block 418 evaluates to “true.” Processing thus proceeds to block 420. For at least one embodiment, additional details for block 420 processing are set forth in FIG. 10.

Turning to FIG. 10 (which is discussed with reference to FIG. 9), one can see that processing for block 420 may begin at block 1002 and proceeds to block 1004. At block 1004, termination processing for the current thread is completed. Processing then proceeds to block 1006. At block 1006, the total modeled execution time for the input sequence of program instructions is calculated. For at least one embodiment, the total modeled execution time takes into account the multithreading behavior modeled as a result of the information provided in the pairset. The execution time may be determined, at block 1006, by determining the commit time for the last thread. The last thread is the thread that has a null value for its “next thread” field. Turning to Tables 10 and 11b, it can be seen that, for our example, the current thread is Thr3, and Thr3 is the last thread. For our example, then, the commit time is determined at block 1006 to be the commit time for Thr3, which is 75.

From block 1106, processing for block 420 ends at block 1008. Returning to FIG. 4, one can see that processing for the method 400 then ends at block 426.

In sum, embodiments of the methods discussed herein provide for determining the effect of a set of spawning pairs on the execution time for a sequence of program instructions for a particular multithreading processor. The spawning pairs indicate concurrent speculative threads that may be spawned during execution of the sequence of program instructions and may thus reduce total execution time. The total execution time is determined by modeling the effects of the spawning pairs on execution of the sequence of program instructions.

Embodiments of the method may be implemented in hardware, software, firmware, or a combination of such implementation approaches. Embodiments of the invention may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the method described herein is not limited in scope to any particular programming language. In any case, the language may be a compiled or interpreted language

The programs may be stored on a storage media or device (e.g., hard disk drive, floppy disk drive, read only memory (ROM), CD-ROM device, flash memory device, digital versatile disk (DVD), or other storage device) readable by a general or special purpose programmable processing system. The instructions, accessible to a processor in a processing system, provide for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

An example of one such type of processing system is shown in FIG. 8. System 800 may be employed, for example, to perform embodiments of speculative multithreading that does not synchronize threads in order to correctly handle data dependencies. System 800 is representative of processing systems based on the Pentium®, Pentium® Pro, Pentium® II, Pentium® III, Pentium® 4, and Itanium® and Itanium® II microprocessors available from Intel Corporation, although other systems (including personal computers (PCs) having other microprocessors, engineering workstations, set-top boxes and the like) may also be used. In one embodiment, sample system 800 may be executing a version of the WINDOWS® operating system available from Microsoft Corporation, although other operating systems and graphical user interfaces, for example, may also be used.

FIG. 8 illustrates that processing system 800 includes a memory system 850 and a processor 804. The processor 804 may be, for one embodiment, a processor 100 as described in connection with FIG. 1, above. Like elements for the processors 100, 804 in FIGS. 1 and 8, respectively, bear like reference numerals.

Processor 804 includes N thread units 104a-104n, where each thread unit 104 may be (but is not required to be) associated with a separate core. For purposes of this disclosure, N may be any integer >1, including 2, 4 and 8. For at least one embodiment, the processor cores 104a-104n may share the memory system 850. The memory system 850 may include an off-chip memory 802 as well as a memory controller function provided by an off-chip interconnect 825. In addition, the memory system may include one or more on-chip caches (not shown).

Memory 802 may store instructions 840 and data 841 for controlling the operation of the processor 804. For example, instructions 840 may include a compiler program 808 that, when executed, causes the processor 804 to compile a program (not shown) that resides in the memory system 802. Memory 802 holds the program to be compiled, intermediate forms of the program, and a resulting compiled program. For at least one embodiment, the compiler program 808 includes instructions to model execution of a sequence of program instructions, given a set of spawning pairs, for a particular multithreaded processor.

Memory 802 is intended as a generalized representation of memory and may include a variety of forms of memory, such as a hard drive, CD-ROM, random access memory (RAM), dynamic random access memory (DRAM), static random access memory (SRAM) and related circuitry. Memory 802 may store instructions 840 and/or data 841 represented by data signals that may be executed by processor 804. The instructions 840 and/or data 841 may include code for performing any or all of the techniques discussed herein. For example, at least one embodiment of a method for determining an execution time is related to the use of the compiler 808 in system 800 to cause the processor 804 to model execution time, given one or more spawning pairs, as described above. The compiler may thus, given the spawn instructions indicated by the spawning pairs, model a multithreaded execution time for the given sequence of program instructions.

Turning to FIG. 12, one can see that an embodiment of compiler 808 may include a sequence of instructions 1200 to perform at least one embodiment of the method 400 described above in connection with FIGS. 4, 5, 6, 7, and 10. The instructions 1200 may receive as an input a program trace or other representation of a sequence of program instructions to be evaluated.

The instructions 1200 may also receive as an input a pairset that identifies spawn instructions for helper threads. For at least one embodiment, each spawn instruction is represented as a spawning pair that includes a spawn point identifier and a target point identifier. As is mentioned above, the target point identifier may be a control-quasi-independent point. FIG. 12 illustrates that the instructions 1200 may also receive as an input an indication of the number of thread units corresponding to a target processor.

As is indicated in the discussion of FIGS. 4 and 9, above, the instructions 1200 may annotate the input trace with the cumulative start time for each key basic block. Using this annotated information, along with the three inputs described above, the instructions 1200 may model behavior of the input trace, as affected by the speculative threads identified in the pairset, to determine a total execution time for the program instructions identified by the program trace.

Specifically, FIG. 12 illustrates that the compiler 808 may include a first block modeler 1220 that, when executed by the processor 804 (FIG. 8), performs first basic block processing 408 as described above in connection with FIGS. 4 and 5. The first block modeler 1220 may, for example, model spawning of a main thread to execute the program instructions represented by the input trace.

The compiler 808 may also include a spawn block modeler 1222 that, when executed by the processor 804 (FIG. 8), performs spawn point basic block processing 416 as described above in connection with FIGS. 4 and 6. The spawn block modeler 1222 may, for example, model the spawning of a speculative thread to execute a subset of the instructions represented by the input trace.

The compiler 808 may also include target block modeler 1224, when executed by the processor 804 (FIG. 8), performs target basic block processing 412 as described above in connection with FIGS. 4 and 7. The target block modeler 1224 may, for example, model concurrent execution of a speculative thread and a main thread. For at least one embodiment, such modeling may include modification of the global current time value to reflect the spawn time of the speculative thread (see, for example, block 716 of FIG. 7).

Also, the compiler 808 may include a last block modeler 1226 that, when executed by the processor 804 (FIG. 8), performs last basic block processing 420 as described above in connection with FIGS. 1 and 10. For at least one embodiment, the last block modeler 1226 may, for example, determine a latest commit time by identifying the commit time for the last thread. Such latest commit time may be utilized to determine a total execution time.

While particular embodiments of the present invention have been shown and described, it will be obvious to those skilled in the art that changes and modifications can be made without departing from the present invention in its broader aspects. The appended claims are to encompass within their scope all such changes and modifications that fall within the true scope of the present invention.

What is claimed is:

1. A method, comprising:
determining, for a target processor, an execution time for a sequence of program instructions;
wherein said determining includes modeling execution of the program instructions and further includes modeling the effect of one at least one concurrent speculative thread on the execution time;
wherein the target processor includes a plurality of thread units.

2. The method of claim 1, wherein:
modeling execution of the program instructions further comprises analyzing a program trace that represents the program instructions.

3. The method of claim 1, further comprising:
receiving as an input a set of one or more spawning pairs, wherein each spawning pair identifies a spawn point and target point for one of the at least one speculative thread.

4. The method of claim 1, wherein modeling the effect of at least one concurrent speculative thread further comprises:
maintaining state information for each of the speculative threads that is active at a current time.

5. The method of claim 2, wherein:
modeling execution of the program instructions further comprises performing modeling for key basic blocks of the trace;
wherein the key basic blocks include the first basic block of the trace, the last basic block of the trace, any basic block defined as the spawn point for any of the one or more concurrent speculative threads, and any basic block defined as the target point for any of the one or more concurrent speculative threads.

6. The method of claim 2, wherein said determining further comprises:
sequentially traversing the basic blocks of the program trace.

7. The method of claim 1, wherein said determining further comprises:
modeling the spawning of a thread to execute the program instructions.

8. The method of claim 1, wherein said determining further comprises:
determining, for a selected one of the speculative threads, whether one of the thread units is available to execute the speculative thread.

9. The method of claim 8, wherein said determining whether one of the thread units is available further comprises:
determining whether spawning of a thread more speculative than the selected speculative thread has already been modeled during a current execution of the method.

10. The method of claim 1, wherein said determining further comprises:
reducing the total execution time to take into account concurrent execution time during which the one or more speculative threads executes a second subset of the program instructions while a non-speculative thread executes a first subset of the program instructions.

11. An article comprising:
a machine-accessible medium having a plurality of machine accessible instructions;
wherein, when the instructions are executed by a processor, the instructions provide for:
determining, for a target processor, an execution time for a sequence of program instructions;
wherein said determining comprises modeling execution of the program instructions and further comprises modeling an effect of one or more concurrent speculative threads on the execution time;
wherein the target processor comprises a plurality of thread units and is capable of performing speculative multithreading.

12. The article of claim 11, wherein instructions that provide for modeling execution of the program instructions further comprise:
instructions that provide for analyzing a program trace that represents the program instructions.

13. The article of claim 11, wherein the plurality of machine accessible instructions, when executed by a processor, further provide for:
receiving as an input a set of one or more spawning pairs, wherein each spawning pair identifies a spawn point and target point for one of the one or more speculative threads.

14. The article of claim 11, wherein the instructions that provide for modeling the effect of one or more concurrent speculative threads further comprise instructions that provide for:
maintaining state information for each of the speculative threads that is active at a current time.

15. The article of claim 12, wherein the instructions that provide for modeling execution of the program instructions further comprise instructions that provide for:
performing modeling for key basic blocks of the trace;
wherein key basic blocks include the first basic block of the trace, the last basic block of the trace, any basic block defined as the spawn point for any of the one or more concurrent speculative threads, and any basic block defined as the target point for any of the one or more concurrent speculative threads.

16. The article of claim 12, wherein the plurality of machine accessible instructions, when executed by a processor, further provide for:
sequentially traversing the basic blocks of the program trace.

17. The article of claim 11, wherein the instructions that provide for determining an execution time for a sequence of program instructions further include instructions that provide for:
modeling the spawning of a single thread to execute the program instructions.

18. The article of claim 11, wherein the instructions that provide for determining an execution time for a sequence of program instructions further include instructions that provide for:
determining, for a selected one of the speculative threads, whether one of the thread units is available to execute the speculative thread.

19. The article of claim 18, wherein the instructions that provide for determining whether one of the thread units is available further include instructions that provide for:
determining whether spawning of a thread more speculative than the selected speculative thread has already been modeled.

20. The article of claim 11, wherein the instructions that provide for determining an execution time for a sequence of program instructions further include instructions that provide for:
reducing the total execution time to take into account concurrent execution time during which the one or more speculative threads executes a second subset of the program instructions while a non-speculative thread executes a first subset of the program instructions.

21. A system, comprising:
a memory;
a processor communicably coupled to the memory, wherein the processor comprises a plurality of thread units; and
a compiler residing in said memory, said compiler to determine, for a sequence of program instructions and at least one spawn instruction, an estimated execution time associated with the processor;
wherein each of the one or more spawn instructions indicates at least one speculative thread.

22. The system of claim 21, wherein:
the compiler is further to model execution of one or more speculative threads, wherein each speculative thread is associated with one of the spawn instructions.

23. The system of claim 22, wherein:
the compiler is further to maintain state information for the one or more speculative threads in order to emulate its evolution over time.

24. The system of claim 21, wherein:
the compiler is further to maintain an estimated commit time for each of a main thread and the speculative threads.

25. The system of claim 24, wherein:
the compiler is further to select the commit time for the latest thread, in sequential program order, as the estimated execution time.

26. A compiler comprising:
a first block modeler to model spawning of a main thread to execute a sequence of program instructions;
a spawn block modeler to model spawning of a speculative thread to execute a subset of the program instructions;
a target block modeler to model concurrent execution of the main thread and the speculative thread; and
a last block modeler to determine a latest commit time from among commit times associated with the modeled main and speculative threads.

27. The compiler of claim 26, wherein:
said first block modeler is further to model spawning of a non-speculative thread to execute the program instructions.

28. The compiler of claim 26, wherein said spawn block modeler is further to:
model spawning of the speculative thread at a spawn point if an associated target point is represented in the program instructions;
wherein said spawning is modeled on a free thread unit, if one is available

29. The compiler of claim 28, wherein:
if a free thread unit is not available, said spawn block modeler is further to:
determine if a more speculative thread with a target point more speculative than the associated target point is currently modeled on a busy thread unit; and
if so, cancel said more speculative thread and model spawning of the speculative thread on the busy thread unit.

30. The compiler of claim 26, wherein said target block modeler further comprises:
determining whether spawning of a speculative thread at a spawn point associated with a current target point is modeled; and:
if so, modifying a current time value to reflect the concurrent execution of the speculative thread with the main thread.

31. The method of claim 1, wherein said at least one speculative thread further comprises:
a precomputation slice.
